(19) United States
(12) Patent Application Publication
(10) Pub. No.: US 2008/0210114 A1
(43) Pub. Date: Sep. 4, 2008

(54) Methods and Apparatus to Deliver Ink to Printing Systems

(76) Inventors: Hongjun X. Ning, Nanjing City (CN); Stephen J. Wilkins, Gurnee, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 10/574,410

(22) PCT Filed: Oct. 1, 2004
(86) PCT No.: PCT/US04/32413

§ 371 Date: Jun. 27, 2007

Related U.S. Application Data
(60) Provisional application No. 60/508,571, filed on Oct. 3, 2003.

(51) Int. Cl. B41L 27/04

(52) U.S. Cl. 101/484

(57) ABSTRACT

Methods and apparatus to deliver ink to printing systems are disclosed. In one example, a disclosed apparatus includes control valves which are coupled to a logic device. Together, the control valves and logic device control the flow of constituent components of press ready ink before the constituent components are mixed into press ready ink and sent to a gravure impression cylinder.

### CROSS REFERENCE TO RELATED APPLICATIONS

This application incorporates by reference and claims the benefit of U.S. Provisional Application No. 60/508,571, filed Oct. 3, 2003.

### TECHNICAL FIELD

This disclosure generally pertains to printing systems and, more particularly, to methods and apparatus to deliver ink to printing systems.

### BACKGROUND

Gravure printing or rotogravure printing is a printing technique characterized by high print quality and large numbers of copies. A gravure impression cylinder contains small cells or cavities that collect ink from an ink well as the partially submerged impression cylinder rotates through the ink well. Shortly after passing through the ink well, the cylinder cells release the collected ink onto a moving paper web. Tiny ink volumes from each cell on the impression cylinder form small printing dots on the paper. Collections of millions of printing dots appear to the human eye as letters/text or images.

As the cylinder rotates through the ink well, the cylinder picks up excess ink in the non-image areas that is not collected in the cells. A blade, brush, or other scouring unit, commonly referred to as a doctor blade, scrapes, or doctors, this excess ink off the impression cylinder, before the impression cylinder comes into contact with the paper web. This excess ink drops into the catch pan, which drains back to the ink reservoir. The level in the ink well is maintained by a continuous flow of ink pumped from the reservoir and a constant overflow arrangement. The overflowing ink cascades into the same catch pan, which receives the ink doctored from the impression cylinder. In addition, as the amount of ink in the ink reservoir supplying each printing unit is gradually depleted, additional raw ink and other constituents are batched into the ink reservoir from a tank farm.

Traditional gravure, or press, printing systems replenish the ink well using a relatively large closed but unsealed reservoir of press ready ink. Press ready ink is composed of a mixture of raw ink, solvent, and varnish. Printing systems using unsealed reservoir ink storage systems present a number of safety concerns and economic inefficiencies based on the nature of the ink used in gravure printing. For example, large volumes of solvent in press ready ink evaporate often creating a flammable volatile gas. In addition, the evaporation of solvent changes the relative composition of the constituent press ready ink components in the remaining ink solution. Finally, the large volume of ink in the reservoir inhibits the ability to change the composition of the ink to meet color specification in a quick and efficient manner. For example, personnel must thoroughly clean the entire reservoir and ink well system and find a place to store the sizable volume of old ink before introducing a new composition of ink into the system. Monthly de-sludging and thorough cleanings of press ready ink reservoirs are also required and can be difficult to schedule during high usage periods.

### BRIEF DESCRIPTION OF THE DRAWINGS

FIG. 1 is a schematic diagram of an example gravure ink delivery system.

FIG. 2 is a schematic diagram of another example of a gravure ink delivery system.

FIG. 3 is a diagram of an example logic device.

FIG. 4 is a flow chart of an example ink delivery process that may be implemented by code operating on the logic device of FIG. 3.

FIG. 5 is a flow chart of another example of an ink delivery process that may be implemented by code operating on the logic device of FIG. 3

### DETAILED DESCRIPTION

Although the following discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware, and/or software. Accordingly, while the following describes example systems, persons of ordinary skill in the art will readily appreciate that the examples are not the only way to implement such systems. Moreover, while the following example describes a gravure ink delivery system, the methods and apparatus disclosed could be used in other ink delivery systems.

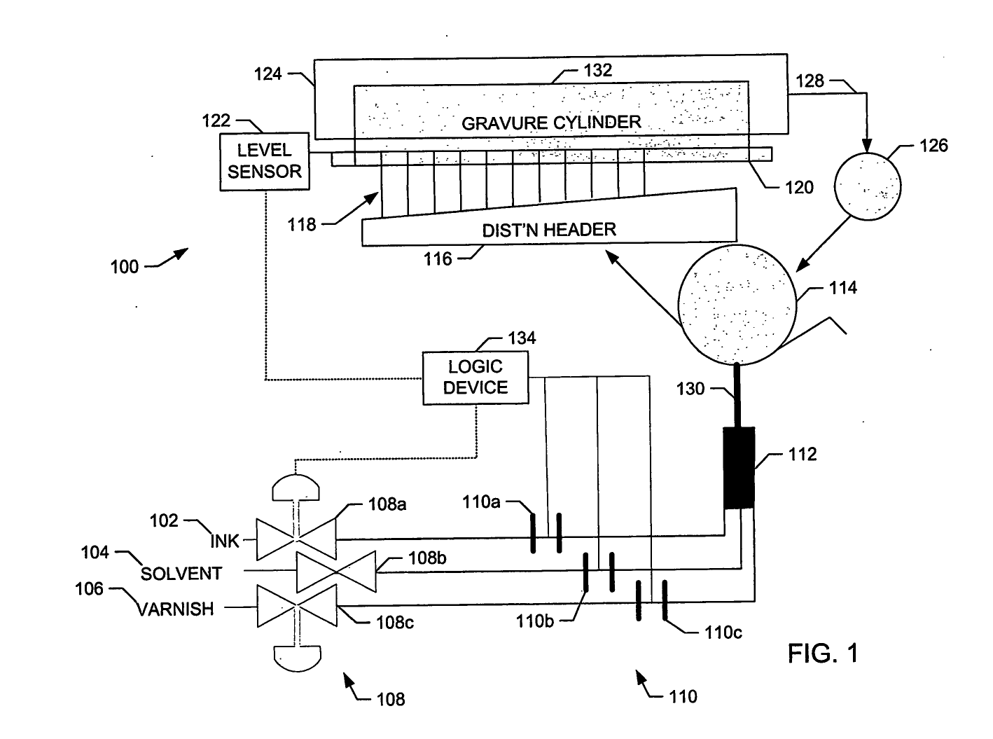

FIG. 1 is a schematic diagram of a gravure ink delivery system 100. The system 100 is fed constituent components of press ready ink including, for example, raw ink 102, solvent 104, and varnish 106. In addition, the system 100 contains one or more control valves 108a-108c, one or more flow meters 110a-110c, an inline static mixer 112, a heat exchanger 114, a distribution header 116, feed lines 118, an ink well 120, a level sensor 122, a catch pan 124, and a recirculation pump 126 that routes the flow of catch pan overflow ink 128 and press ready or “mixed” ink 130 to a gravure impression cylinder 132. In general, a logic device 134 monitors and controls the flow of both mixed ink 130 and the constituent components 102, 104, and 106 to provide a proper ink mixture and flow rate to the ink well 120.

The constituent components of press ready ink include, but are not limited to, raw ink 102, such as Flint 5400, solvent 104, such as Toluene, and varnish 106, such as Flint V5000. Other types of raw ink, solvent, and varnish used to create gravure printing press ready ink are also acceptable and are well known to those ordinarily skilled in the art. Each of the constituent components 102-106 is separately stored from the other components and is typically kept, for example, in large storage tanks containing several thousand gallons of the constituent components. The large storage tanks are located, for example, in a tank farm of the plant. In one example, each constituent component 102-106 is stored in a sealed container that may be individually filled without changing or otherwise interrupting the flow of the entire system 100. The constituent components 102-106 may be directly connected to the control valves 108, or may be connected via individual connecting pipes or tubes.

In one example, the control valves 108a-108c (collectively 108) are precision control valves that receive electrical signals (analog or digital) and respond thereto by increasing or decreasing the flow therethrough. The control valves 108 may be implemented using individual control valves 108a-108c or by a single structure including three control valves 108a-108c. Other suitable control methods will be readily apparent to those ordinarily skilled in the art.

The flow meters 110a-c (collectively 110) are connected downstream of each respective control valve 108 and upstream of the inline static mixer 112. The flow meters 110 monitor the rate of flow of mixed ink 130 and convey this rate to the logic device 134 via digital or analog electrical signals. The inline static mixer 112 such as Ross Inline PDP Static Mixer is located downstream from the control valves 108. The inline static mixer 112 receives each of the constituent components 102, 104, and 106 and contains stationary mixing blades and baffles to mix the constituent components 102, 104, and 106 into a blended or combined mixed ink 130. This is done by converting laminar flow into turbulent flow due to the disruption caused by the flow of the constituent components 102, 104, and 106 as they contact the inline static mixer 112. The flow disruption of the components causes the constituent components 108 to combine into mixed ink 130. Other ways to mix the constituent components 102, 104, and 106 into mixed ink 130 will be apparent to those ordinarily skilled in the art.

The heat exchanger 114 cools the mixed ink 130 with a variable rate of cool water flow based on the temperature of the mixed ink 130. In one example, the heat exchanger 114 automatically adjusts the rate of cool water flow through an internal temperature/flow feedback program. However, in another example, the logic device 134 may regulate the cool water flow rate based on the temperature of the mixed ink 130.

The distribution header 116 uses the feed lines 118 to supply mixed ink 130 to the ink well 120. In one example, the feed lines 118 are generally spaced at even intervals along the length of the ink well 120, thereby allowing the ink to flow evenly through the ink well 120 to maintain a homogeneous ink mixture. Dead areas in which the ink does not flow evenly promote coagulation or precipitation of press ready ink components that foul the ink well and modify the press ready ink composition.

The ink well 120 may be, for example, a shallow well slightly longer than the length of the gravure cylinder 132 and is open on the top side thereby allowing the gravure cylinder 132 to come into contact with, or become partially immersed in, the mixed ink 130. The level sensor 122, such as, for example, a level sensor commercially available from Endress Hauser, uses a radar beam to monitor the level of mixed ink 130 in the ink well 120 and produce an ink level feedback signal that is provided to the logic device 132.

The catch pan 124 collects excess mixed ink 130 doctored from the gravure impression cylinder 132 and the ink well 120 overflow. The excess ink may be scraped, brushed, or otherwise scoured off of the gravure cylinder 132 using a variety of techniques well known to those having ordinary skill in the art.

The recirculation pump 126, such as, for example, a single stage Johnson centrifugal pump conveys excess mixed ink 130 (also known as catch pan overflow ink 128 and doctored ink from the impression cylinder) from the catch pan 124 to the heat exchanger 114, where the overflow ink is cooled before being pumped back to the distribution header 116.

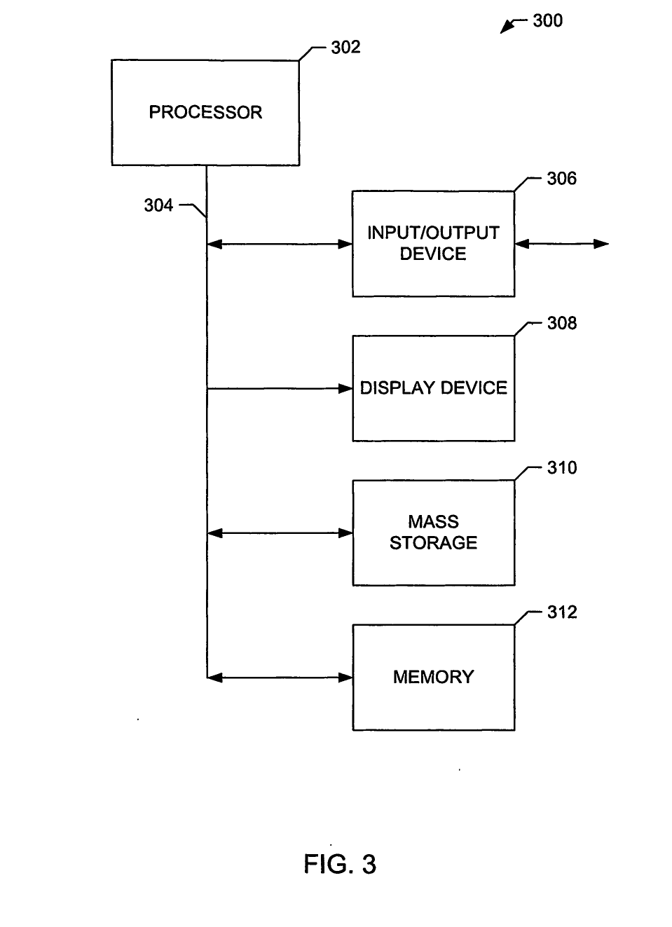

As described in detail in conjunction with FIG. 3, the logic device 132 may be implemented using a personal computer, a programmable logic control (PLC), or any other device that controls the flow of the individual ink components 102, 104, and 106 in response to sensor inputs from the flow meter 110 and level sensor 122. Ink delivery from the control valves 108 in the system 100 will be monitored by the flow meter 110 and level sensor 122 and regulated by the logic device 134.

In operation, the constituent ink components 102, 104, and 106 are separately coupled to the control valves 108. The control valves 108 regulate the flow rates based on input from the logic device 134. At least one individual control valve 108a, 108b, or 108c is assigned to each constituent component 102-106 such that the control valve 108a, 108b, or 108c can control the flow rate of a single constituent component 102, 104, or 106 from the storage containers or tank farm of the constituent component 102, 104, or 106 to the inline static mixer 112. Each constituent component 102, 104, and 106 flows from a control valve 108 into an inline static mixer 112 where the separate constituent components 102, 104, and 106 are mixed into press ready ink 130. Alternatively, the constituent components 102, 104, and 106 may be premixed in a header (not shown) before entry into the inline static mixer 112. As another example, the inline static mixer 112 may mix the constituent components 102-106 with the catch pan overflow ink 128.

In one example using a heat exchanger 114, the mixed ink 130 leaving the inline static mixer 112 is coupled with catch pan ink 128 before flowing through the heat exchanger 114 into the distribution header 116. In another example, the mixed ink 130 leaving the inline static mixer 112 flows directly into the distribution header 116 and mixes with the catch pan ink 128 after the catch pan ink 128 flows through the heat exchanger 114. The heat exchanger cools the mixed ink 130 and/or catch pan overflow ink 128. The techniques of cooling the ink may include a liquid-liquid shell and tube heat exchanger. The rate of flow of ink and/or the amount of cooling in the heat exchanger 114 may be regulated internally by the heat exchanger 114 or by the logic device 134.

Together, the catch pan ink 128 and mixed ink 130 are passed to the distribution header 116. The distribution header feeds the mixed ink 130 into the ink well 120 via the feed lines 118 spaced at even intervals. The level sensor 122 monitors the level of mixed ink 130 in the ink well 120 and provides a feedback signal to the logic device 134 so that the logic device 134 may control the rate of ink flow by regulating the control valves 108.

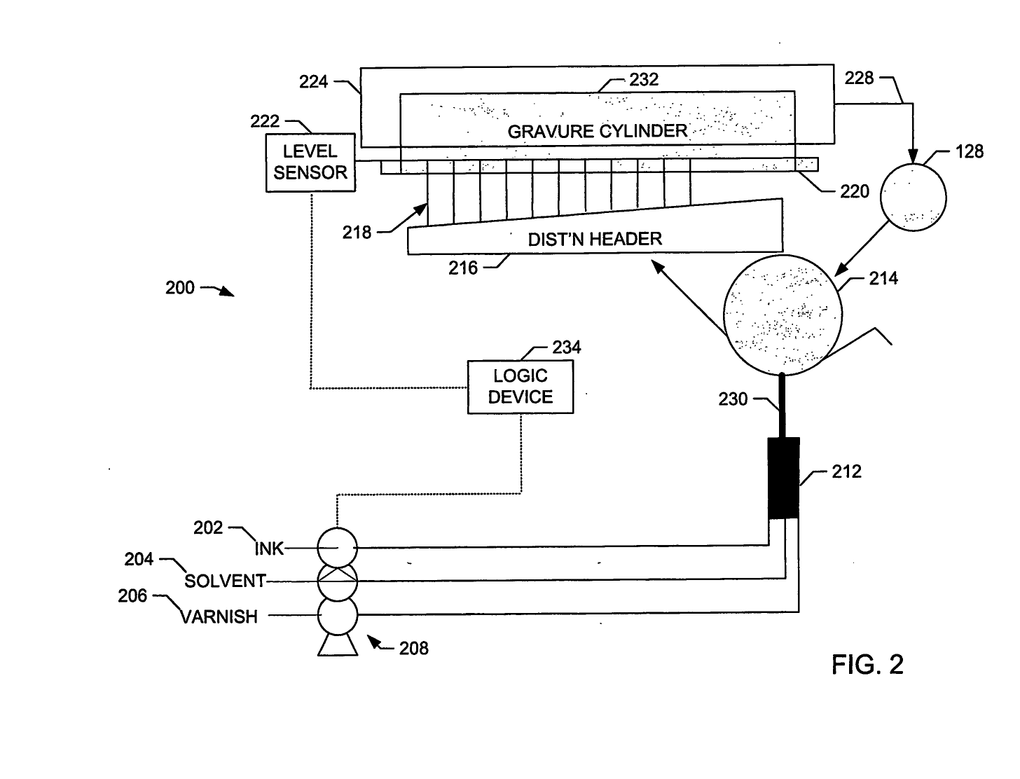

FIG. 2 is a schematic diagram of another example of a gravure ink delivery system 200. With the exception of numbers 108a-108c and 208, note that reference numbers from FIG. 1 correspond to numbers from FIG. 2 with the exception of the first digit. For example, 112 and 212 are analogous components. The system 200 of FIG. 2 is different than the system 100 of FIG. 1 in that system 200 uses a single three-headed VFD pump 208 in place of the control valves 108 and the flow meters 110 of the system 100. The VFD pump 208 is a precision pumping device such as a Lewa Modular Metering Pump that conveys prescribed flow rates of material in response to commands provided by the logic device 234. The VFD pump 208 may adjust the flow rate of each individual constituent component 202, 204, and 206 to adjust the relative volumes of the constituent components 202, 204, and 206 or may adjust the flow of all constituent components 208, thereby affecting the ink flow rate. Additionally, the VFP pump 208 may adjust the flow rate of all the constituent components 202, 204, and 206 to keep their relative mixture the same, thereby adjusting the overall volume of the mixture. The example system 200 of FIG. 2 does not use separate flow meters, although those with ordinary skill in the art will recognize that flow meters may or may not be used in conjunction with the VFP pump 208.

As shown in FIG. 3, in one example, the logic device 134, 234 of FIGS. 1 and 2 may be implemented using a personal computer 300, a programmable logic controller, etc., including, for example, a processor 302. The processor 302 is coupled to an interface, such as a bus 304 to which other components may be interfaced. In the illustrated example, the components interfaced to the bus 304 include an input/output device 306, display device 308, mass storage unit 310, and memory 312 which may be separate components or, alternatively, housed together in a single unit.

The example processor 302 may be, for example, a conventional desktop personal computer, a notebook computer, a workstation, or any other computing device and may be of any type of processing unit, such a microprocessor from the Intel® Pentium® family of microprocessors. The memory 312 that is coupled to the processor 302 may be any suitable memory device and may be sized to fit the storage demands of the system 300.

The input/output device 304 may be implemented using a keyboard, a mouse, a touch screen, a track pad, or any other device that enables a user to provide information to the processor 302. Output may be implemented via, for example, COM, I/O, ethernet, modem ports, etc. and may be connected to other machines that can interpret data from the processor 302. Other example output devices include, but are not limited to, printers, modems, networked computers, speakers, fax machines, copiers, etc.

The display device 308 may be, for example, a liquid crystal display (LCD) monitor, a cathode ray tube (CRT) monitor, or any other suitable device that acts as an interface between the processor 302 and a user. In addition, the display device 308 may be the same device as the input/output device 304, such as a touch screen monitor. The mass storage device 310 may be, for example, a conventional hard drive or any other magnetic or optical media that is readable by the processor 302.

Other additions or examples of the system 300 may include a removable storage device drive such as a compact disk, digital versatile disk, floppy disk, magnetic storage tape, etc. Moreover, additional or alternative memory components may be used such as random access memory, flash memory, read only memory, and the like. Other additions or modifications to the general structure of the system will be readily apparent to those ordinarily skilled in the art.

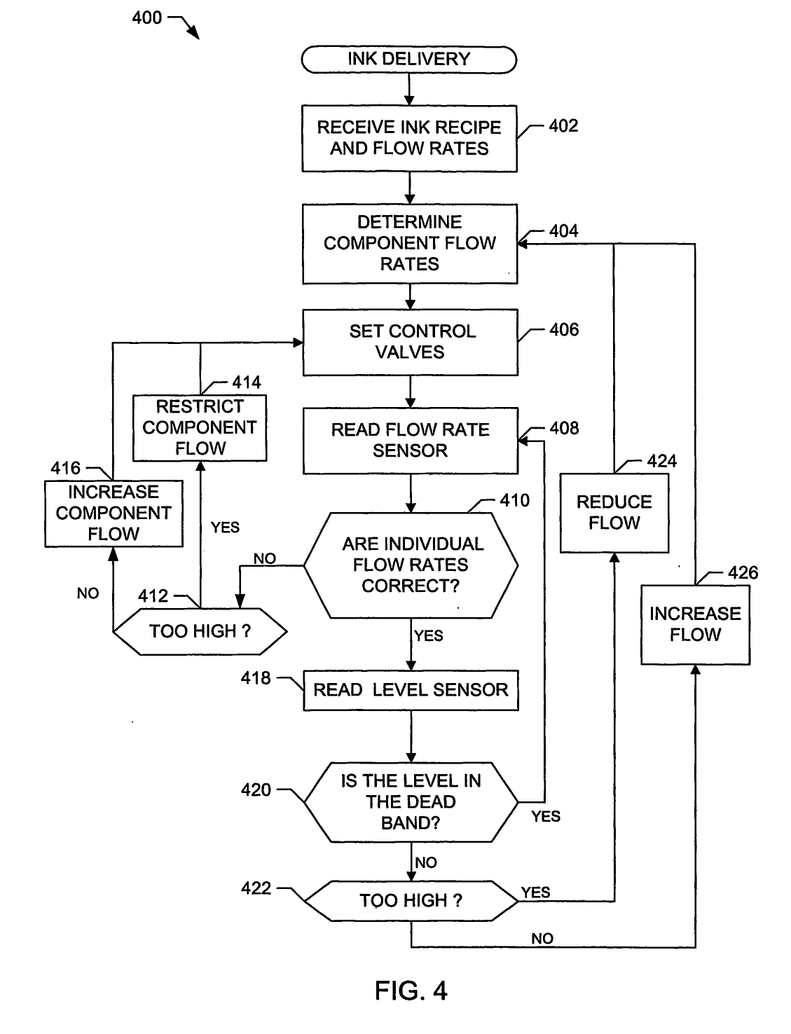

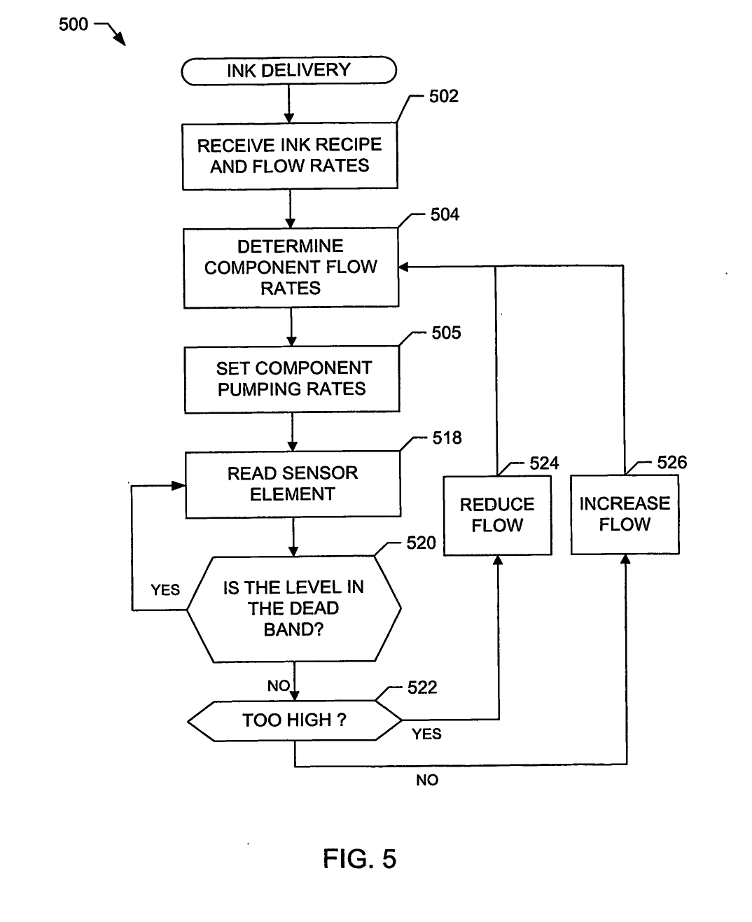

In operation, the processor 302 reads instructions from the mass storage device 310 and/or the memory 312 and executes such instructions to control the ink delivery systems 100 and 200 of FIGS. 1 and 2 as described in detail with respect to FIGS. 4 and 5, respectively. It will be understood, however, that one or more of these processes may be carried out by different processor systems.

As shown in FIG. 4, the ink delivery process 400 begins operation by determining the proper ink recipe (block 402). This may be directly received from a user or may be stored in mass storage 310 or memory 312. For ease of description, reference numbers from FIGS. 1 and 3 are used to describe components affected by the flow diagrams of FIG. 4 and reference numbers from FIGS. 2 and 3 are used to describe components affected by the flow diagram of FIG. 5. Moreover, one of ordinary skill in the art will recognize that the processes depicted in FIGS. 4 and 5 may be carried out using other components.

An example press ready ink formula might be one part raw ink 102, one-half part solvent 104, and one-fifth part varnish 106. Based on the size of the gravure cylinder 132, the volume of the ink well 120, and other factors, the logic device 134 will determine the proper flow rates for each constituent component 102-106 (block 404). As an example, appropriate flow rates may be twelve gallons/hour raw ink 102, six gallons/hour solvent 104, and 2.4 gallons/hour varnish 106.

Based on the constituent component flow rates (block 404), the logic device 134 sets the control valves 108 to allow the proper flow of each constituent component 102-106 to pass (block 406). The flow meter 110 provides flow rate data to the logic device 134, which reads the data (block 408) and determines if the flow rates are correct (block 410).

If the flow rates are incorrect, the process 400 determines if the flow rate is too high (block 412). If the flow rate is too high (block 412), the logic device 134 incrementally closes one or more of the control valves 108 an incremental amount (block 414) to reduce the flow. In one example, the control valves 108 corresponding to high flow rates are adjusted to reduce the flow therethrough by 5%.

If the flow rates are not too high (block 412), the logic device incrementally opens one or more of the control valves 108 an incremental amount (block 416) to increase the flow. In one example, the control valves 108 corresponding to the low flow rates are adjusted to increase the flow therethrough by 5%.

Alternatively, if the flow rates are correct, the logic device 134 then reads the level sensor 122 in the ink well 120 (block 418). The logic device 134 ascertains whether the level of mixed ink 130 is within an acceptable range known as the dead band (block 420). For example, a 10% dead band would find acceptable either 5% more than or 5% less than the target amount of mixed ink 130 in the ink well 120. Using this example, if the target amount of mixed ink 130 in the ink well 120 is sixty gallons, the dead band would be the range between 57 and 63 gallons. If the level of mixed ink 130 resides in the dead band, the flow rate of the control valves 108 remains the same and the logic device 134 returns to block 408 to read the flow rates from the flow meter 110.

If the level sensor 122 indicates that the level of mixed ink 130 in the ink well 120 is not within the dead band, the process 400 determines if the level is too high (block 422). If the level of mixed ink 130 in the ink well 120 is too high (i.e., above the dead band) (block 422), the logic device 134 reduces the overall flow rate by a predetermined percentage such as 5% (block 424) by incrementally closing all of the control valves 108 by an equally proportional amount. The logic device 134 then reevaluates and modifies the constituent component flow rates in block 404.

If the level of mixed ink 130 in the ink well 120 is not too high (i.e., above the dead band), the logic device 134 increases the overall flow rate by a predetermined percentage such as 5% (block 426) by incrementally opening all of the control valves 108 by an equally proportional amount. The logic device 134 then reevaluates and modifies the constituent component flow rates in block 404.

FIG. 5 is another example of an ink delivery process that may be implemented by code operating on the logic device of FIG. 3. As shown in FIG. 5, the ink delivery process 500 begins operation by determining the proper ink recipe (block 502). This may be directly received from a user or may be stored in mass storage 310 or memory 312.

Based on the size of the gravure cylinder 232, the volume of the ink well 220, and other factors, the logic device 234 will determine the proper flow rates for each constituent component 202-206 (block 504). As an example, appropriate flow rates may be twelve gallons/hour raw ink 202, six gallons/hour solvent 204, and 2.4 gallons/hour varnish 206.

Based on the constituent component flow rates (block 504), the logic device 234 sets the VFD pump 208 to allow the proper flow of each constituent component 202-206 to pass (block 505). The logic device 234 then reads the level sensor 222 in the ink well 220 (block 320). The logic device 234 ascertains whether the level of mixed ink 230 is within an acceptable range known as the dead band (block 420). For example, a 10% dead band would find acceptable either 5% more than or 5% less than the target amount of mixed ink 230 in the ink well 220. Using this example, if the target amount of mixed ink 230 in the ink well 220 is sixty gallons, the dead band would be the range between 57 and 63 gallons. If the level of mixed ink 230 resides in the dead band, the flow rate of the VFD pump 208 remains the same and the logic device 234 returns to block 518 to read the flow rates from the level sensor 222.

If the level sensor 222 indicates that the level of mixed ink 230 in the ink well 220 is not within the dead band, the process 500 determines if the level is too high (block 522). If the level of mixed ink 230 in the ink well 220 is too high (i.e., above the dead band) (block 522), the logic device 234 reduces the overall flow rate by a predetermined percentage such as 5% (block 524) by incrementally reducing the flow of the VFP pump 208. The logic device 234 then reevaluates and modifies the constituent component flow rates in block 504

If the level of mixed ink 230 in the ink well 220 is not too high (i.e., above the dead band), the logic device 234 increases the overall flow rate by a predetermined percentage such as 5% (block 526) by incrementally increasing the flow of the VFD pump 208. The logic device 234 then reevaluates and modifies the constituent component flow rates in block 504.

While the foregoing describes preferred embodiments of the invention, it will be obvious to those with ordinary skill in the art that other configurations may be implemented. The foregoing description has been presented for the purposes of illustration and description and is not intended to be exhaustive or to limit this patent to the examples disclosed. Many modifications and variations are possible in light of the above teachings. It is intended that the scope of the invention not be limited by this detailed description of examples.

1. A method of delivering ink to a printing system, the method comprising:
delivering one or more constituent components of press ready ink from separate storage containers toward an ink well;
receiving flow rate values indicative of the flow rates of the constituent components of the press ready ink;
setting flow devices to deliver the constituent components at a defined rate of flow based on the received flow rate values;
mixing the constituent components into press ready ink in-line during delivery of the constituent components from the storage containers to the ink well; and
receiving the press ready ink in the ink well.

2. A method as defined in claim 1, further comprising adjusting the rates of flow of the constituent components via the flow devices based on the level of the press ready ink in the ink well.

3. A method as defined in claim 2, wherein the flow devices increase the rates of flow of the constituent components if the level of the press ready ink in the ink well is too low.

4. A method as defined in claim 1, wherein one or more sensors read the flow rates of the constituent components of the press ready ink.

5. A method as defined in claim 4, wherein the flow rates of the constituent components are adjusted based on the flow rates read by the sensors.

6. A method as defined in claim 1, wherein receiving the flow rate values indicative of the flow rates of the constituent components of the press ready ink comprises receiving at least a portion of a press ready ink recipe specifying the flow rate values.

7. A method as defined in claim 1, wherein the flow devices are variable flow pumps.

8. A method of delivering ink to a printing system, the method comprising:
delivering at least two constituent components of press ready ink toward an ink well;
receiving a first flow rate value associated with the first constituent component and a second flow rate value associated with the second constituent component;
setting first and second pumps to deliver the constituent components at rates of flow based on the first and second flow rate values; and
receiving the press ready ink in an ink well.

9. A method as defined in claim 8, wherein receiving the first and second flow rate values comprises receiving at least a portion of a press ready ink recipe specifying the first and second flow rate values.

10. A method as defined in claim 8, further comprising setting the first and second pumps to deliver the constituent components at a rate of flow based on a level of press ready ink in the ink well.

11. A method as defined in claim 10, wherein delivering the at least two constituent components of the press ready ink toward the ink well comprises delivering the at least two constituent components to an in-line mixing structure, wherein the in-line mixing structure creates the press ready ink by mixing the constituent components.

12. A method of delivering ink to a printing system, the method comprising:
delivering a plurality of constituent components of press ready ink toward an ink well;
measuring flow rates of the constituent components;
setting flow control valves to deliver the constituent components at rates of flow based on the measured flow rates;
mixing the constituent components into press ready ink in-line during delivery of the constituent components; and
collecting the press ready ink in the ink well.

13. A method as defined in claim 12, wherein delivering the plurality of constituent components comprises delivering the plurality of constituent components to a mixing structure to mix the constituent components into the press ready ink.

14. A method as defined in claim 13, wherein measuring the flow rates of the constituent components includes measuring the flow rates during delivery of the plurality of constituent components before the constituent components reach the mixing structure.

15. A method as defined in claim 12, further comprising setting the flow control valves to deliver the constituent components at rates of flow based on a level of press ready ink in the ink well.

16. A system to deliver ink to a printing system, the system comprising:
an in-line mixing structure to receive at least first and second constituent components of press ready ink and mix the first and second constituent components to make the press ready ink;
a first flow control device coupled between a first storage container and the mixing structure to control the rate of flow of the first constituent component of the press ready ink between the first storage container and the mixing structure based on a first flow rate value of the first constituent component;
a second flow control device coupled between a second storage container and the mixing structure to control the rate of flow of the second constituent component of the press ready ink between the second storage container and the mixing structure based on a second flow rate value of the second constituent component; and
an ink well coupled to the mixing structure to receive the press ready ink from the mixing structure.

17. A system as defined in claim 16, further comprising first and second sensors coupled between the first and second storage containers and the mixing structure to measure flow rates of the first and second components.

18. A system as defined in claim 16, further comprising a control device to adjust the first and second flow control devices based on the first and second flow rate values to change the rates of flow of the constituent components.

19. A system as defined in claim 18, wherein the first and second flow rate values are specified in a press ready ink recipe, and wherein the control device receives at least a portion of the press ready ink recipe.

20. A system as defined in claim 16, wherein the first and second flow control devices are pumps.
